(19) United States
(12) Patent Application Publication
(10) Pub. No.: US 2018/0339477 A1
(43) Pub. Date: Nov. 29, 2018

(54) BEAD FILLER FORMING DEVICE

(71) Applicant: TOYO TIRE & RUBBER CO., LTD., Itami-shi (JP)

(72) Inventors: Ryoshi Miyamoto, Itami-shi (JP); Yoshiki Hashimoto, Itami-shi (JP)

(73) Assignee: TOYO TIRE & RUBBER CO., LTD., Itami-shi (JP)

(21) Appl. No.: 15/988,037

(22) Filed: May 24, 2018

(30) Foreign Application Priority Data
May 29, 2017 (JP) 2017-105296

(51) Int. Cl. B29D 30/48; B29D 30/32

(52) U.S. Cl. CPC B29D 30/48; B29D 2030/0044; B29D 30/32

(57) ABSTRACT

In a bead filler forming device configured to forma bead filler by annularly applying, to a forming surface of a rotating table, rubber extruded via a mouthpiece from an extruder in a band shaped manner, and by joining end portions of the band-shaped rubber. The mouthpiece includes a leading end surface, a discharge port which is formed in the leading end surface, a land portion which extends from the discharge port in a single cross section, and a flow rate regulating portion which is provided in an upstream side of the land portion and makes a flow rate of the rubber flowing to an outer peripheral side flow path of the land portion larger than a flow rate of the rubber flowing to an inner peripheral side flow path of the land portion.

### BACKGROUND OF THE INVENTION

### Field of the Invention

The present invention relates to a bead filler forming device that forms a bead filler by annularly applying, to a forming surface of a rotating table, rubber extruded via a mouthpiece from an extruder in a band-shaped manner, and by joining end portions of the band-shaped rubber.

### Description of the Related Art

In general, in a case of manufacturing a pneumatic tire, the pneumatic tire is manufactured by forming a green tire by applying tire constituting members, such as an inner liner, a side wall, a bead, and a tread, to each other in an unvulcanized state, and vulcanizing the green tire.

The bead includes a bead core which forms a reinforcing member, and a bead filler which is made of rubber having an approximately triangular cross section. Conventionally, the annular bead filler is formed by extruding the band-like rubber having the cross sectional shape mentioned above from the extruder, cutting the rubber at a fixed length, and joining the end portions of the rubber each other. However, in the case that the end portions of the rubber formed material extruded from the extruder are simply annularly joined when the bead filler is formed, a tensile stress in a peripheral direction acts on an outer peripheral portion due to an inner and outer peripheral length difference. As a result, there is generated a problem that the bead filler is peeled at the joint portion of the end portions and is rolled back in the outer peripheral portion.

Patent Document 1 discloses a bead filler forming device including a bead retention portion which retains an annular bead core, and an extruder which extrudes a filler rubber for forming a bead filler, and being configured to form the bead filler on an outer peripheral surface of the bead core which is retained by the bead retention portion, wherein a forming disc which is rotatable around a center axis line of the bead core together with the bead retention portion is attached to and arranged in a side surface of the bead retention portion, and a mouthpiece is arranged in the vicinity of the forming disc, defining a space corresponding to a transverse cross sectional shape of the bead filler together with the forming disc and an outer peripheral surface of the bead core and discharging the filler rubber extruded from the extruder in the space.

In the bead filler forming device, a bead filler 9 is formed in a space which is defined by a forming surface 40a of a forming disc, an outer peripheral surface of a bead core 8, and a discharge surface 30a of a mouthpiece, as shown in FIG. 6. However, since the discharge surface 30a is inclined in relation to the forming surface 40a of the forming disc, a wall surface length of a flow path wall in an inner peripheral side is shorter than a wall surface length of a flow path wall in an outer peripheral side at a distance A, in a rubber flow path which is formed within the mouthpiece. As a result, an amount of rubber extruded to an inner peripheral side portion of the bead filler 9 is more than an amount of rubber extruded to an outer peripheral side portion. Therefore, a thickness becomes large in the inner peripheral side portion and a thickness becomes small in the outer peripheral side portion. Thus, a leading end is curled due to an inner and outer peripheral length difference, and it becomes hard to precisely form the bead filler 9 having a desired cross sectional shape.

### PRIOR ART DOCUMENT

Patent Document
Patent Document 1: JP-A-2015-13403

### SUMMARY OF THE INVENTION

The present invention has been made by considering the above actual situation, and an object of the present invention is to provide a bead filler forming device which can precisely form a bead filler having a desired cross sectional shape.

The above object can be achieved by the present invention as described below.

More specifically, a bead filler forming device according to the present invention is a bead filler forming device including an extruder, a rotating table, and a mouthpiece, and being configured to form a bead filler by annularly applying, to a forming surface of the rotating table, rubber extruded via the mouthpiece from the extruder in a band shaped manner, and by joining end portions of the band-shaped rubber,

wherein the mouthpiece includes:

a leading end surface which is arranged to be inclined in relation to the forming surface of the rotating table in such a manner that a distance from the forming surface of the rotating table is larger in an inner peripheral side of the leading end surface than in an outer peripheral side of the leading end surface;

a discharge port which is formed in the leading end surface;

a land portion which extends from the discharge port in a single cross section in such a manner as to be inclined to an outer peripheral side of the rotating table in relation to a rotating shaft of the rotating table toward a direction of being away from the forming surface; and

a flow rate regulating portion which is provided in an upstream side of the land portion and makes a flow rate of the rubber flowing to an outer peripheral side flow path of the land portion larger than a flow rate of the rubber flowing to an inner peripheral side flow path of the land portion.

In the bead filler forming device according to the present invention, a wall surface length of a flow path wall in the inner peripheral side flow path is preferably between 60 and 200% of a wall surface length of a flow path wall in the outer peripheral side flow path.

In the bead filler forming device according to the present invention, a wall surface length of a flow path wall in the inner peripheral side flow path is preferably equal to a wall surface length of a flow path wall in the outer peripheral side flow path.

In the bead filler forming device according to the present invention, a rubber flowing direction in the land portion is preferably equal to a rubber flowing direction in the flow rate regulating portion.

In the bead filler forming device according to the present invention, a rotating shaft of a screw for extruding the rubber built in the extruder is preferably arranged in parallel to the rotating shaft of the rotating table.

In the bead filler forming device according to the present invention, a leading end of the extruder is preferably provided with a die which leads the rubber supplied from the extruder to the mouthpiece, and a leading end surface of the die is preferably formed to be inclined in relation to the forming surface of the rotating table in such a manner that a distance from the forming surface of the rotating table is larger in an inner peripheral side of the leading end surface than in an outer peripheral side of the leading end surface.

In the bead filler forming device according to the present invention, the flow rate regulating portion is provided in the upstream side of the land portion extending from the discharge port. Therefore, the flow rate regulating portion can make the flow rate of the rubber flowing to the outer peripheral side flow path of the land portion larger than the flow rate of the rubber flowing to the inner peripheral side flow path of the land portion. However, even in the case that the flow rate regulating portion makes the flow rate of the rubber flowing to the outer peripheral side flow path larger than the flow rate of the rubber flowing to the inner peripheral side flow path, the flow rate of the rubber in the inner peripheral side flow path is increased and the flow rate of the rubber in the outer peripheral side flow path is reduced if the wall surface length of the flow path wall in the inner peripheral side flow path of the land portion is too shorter than the wall surface length of the flow path wall in the outer peripheral side flow path such as in the conventional mouthpiece. As a result, it is hard to form the bead filler having a desired cross sectional shape.

According to the present invention, the difference is small between the wall surface length of the flow path wall in the inner peripheral side flow path of the land portion supplying the rubber to the inner peripheral side portion of the bead filler, and the wall surface length of the flow path wall in the outer peripheral side flow path of the land portion supplying the rubber to the outer peripheral side portion of the bead filler even in the case that the leading end surface of the mouthpiece is inclined to the forming surface of the rotating table. As a result, the rubber the flow rate of which is regulated by the flow rate regulating portion is discharged out of the discharge port without being affected by the land portion, and it is possible to precisely form the bead filler having the desired cross sectional shape.

### BRIEF DESCRIPTION OF THE DRAWINGS

FIG. 1 is a perspective view showing an example of a bead filler forming device;

FIG. 2 is a front elevational view showing a principal part of the bead filler forming device;

FIG. 3 is a cross sectional view of a mouthpiece along a rubber flow path;

FIG. 4 is a front elevational view of a bead filler forming device according to another embodiment;

FIG. 5 is a front elevational view of a bead filler forming device according to another embodiment; and

FIG. 6 is a front elevational view of a bead filler forming device according to the related art.

### DETAILED DESCRIPTION OF THE PREFERRED EMBODIMENTS

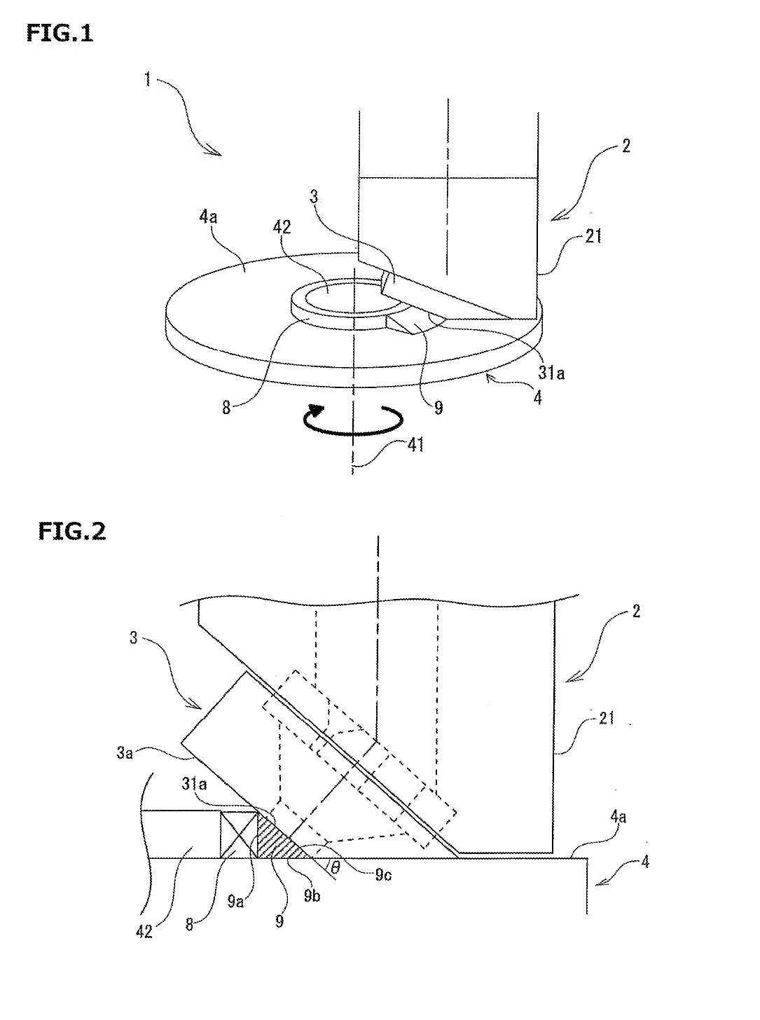

A description will be given below of embodiments according to the present invention with reference to the accompanying drawings. FIG. 1 is a perspective view showing an overall structure of a bead filler forming device 1. FIG. 2 is a front elevational view showing a principal part of the bead filler forming device 1 in FIG. 1 in an enlarged manner.

As shown in FIG. 1, the bead filler forming device 1 is provided with an extruder 2, a mouthpiece 3 which discharges, from a discharge port 31a, rubber extruded out of the extruder 2, and a rotating table 4. The bead filler forming device 1 forms a bead filler 9 by annularly applying, to a forming surface 4a of the rotating table 4, rubber extruded via the mouthpiece 3 from the extruder 2 in a band shaped manner, and joining end portions of the band-shaped rubber to each other.

As shown in FIGS. 1 and 2, the present embodiment describes an example in which the annular bead filler 9 is obtained by annularly forming the band-shaped rubber having a triangular cross sectional shape which is tapered in its outer peripheral portion. An annular bead core 8 is joined to a radial inner peripheral surface 9a of the bead filler 9. The bead filler 9 is formed of a hard rubber, and the bead core 8 is formed of a convergent body of such as a steel wire. The bead core 8 is retained by a bead lock mechanism 42 which is provided in the table 4.

The bead filler 9 has an approximately right triangular cross sectional shape, and has a radial inner peripheral surface 9a which corresponds to a bottom side of the triangle, an upright side surface 9b which corresponds to one oblique side of the triangle, and an inclined side surface 9c which corresponds to the other oblique side of the triangle. The radial inner peripheral surface 9a comes into contact with an outer peripheral surface of the bead core 8, and the upright side surface 9b comes into contact with a forming surface 4a of the table 4.

The extruder 2 has a hopper in which the rubber material is thrown, and a screw which extrudes the rubber material forward while applying heat thereto, which are not illustrated. In the extruder 2, an extruding amount of the rubber is controlled, for example, to a fixed amount by controlling a rotating speed of the screw by a control device (not shown). In the present embodiment, a rotating shaft of the screw for extruding the rubber built in the extruder 2 is arranged in parallel to a rotating shaft 41 of the table 4.

The mouthpiece 3 has a leading end surface 3a in which the discharge port 31a is formed. The leading end surface 3a is arranged to be inclined in relation to the forming surface 4a in such a manner that a distance from the forming surface 4a of the table 4 becomes larger in an inner peripheral side of the leading end surface 3a than in an outer peripheral side of the leading end surface 3a. An angle of gradient θ of the leading end surface 3a in relation to the forming surface 4a is set to be equal to an angle which is formed by the upright side surface 9b and the inclined side surface 9c of the formed bead filler 9.

In the present embodiment, the rubber discharged out of the discharge port 31a is filled in a space which is defined by three surfaces including the leading end surface 3a of the mouthpiece 3, the forming surface 4a of the table 4, and the outer peripheral surface of the bead core 8, and then the table 4 is rotated together with the bead core 8 while the rubber is continuously discharged out of the discharge port 31a. As a result, it is possible to form the bead filler 9 having a desired cross sectional shape by three surfaces including the leading end surface 3a of the mouthpiece 3, the forming surface 4a of the table 4, and the outer peripheral surface of the bead core 8.

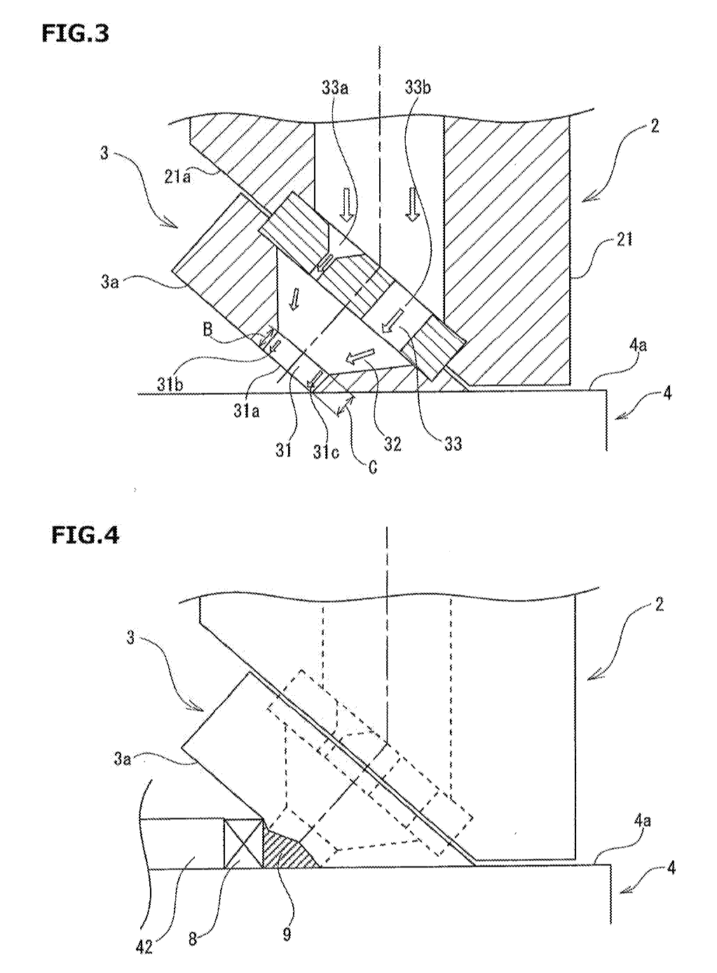

The mouthpiece 3 is provided in its inner portion with a rubber flow path through which the rubber supplied from the extruder 2 passes, and the discharge port 31a is formed in a downstream side thereof. FIG. 3 is a cross sectional view along the rubber flow path of the mouthpiece 3. The rubber flow path of the mouthpiece 3 includes a land portion 31, a taper portion 32, and a flow rate regulating portion 33 in order from a downstream side.

The land portion 31 extends toward an upstream side from the discharge port 31a in a single cross section. The extending direction of the land portion 31 is a direction which is inclined to an outer peripheral side of the rotating table 4 in relation to the rotating shaft 41 of the table 4 so as to be away from the forming surface 4a of the table 4. In the present embodiment, the extending direction of the land portion 31 is approximately vertical to the inclined side surface 9c of the bead filler 9.

Here, in the rubber flow path of the land portion 31, a portion which supplies the rubber to an inner peripheral side portion of the bead filler 9 is set to an inner peripheral side flow path 31b, and a portion which supplies the rubber to an outer peripheral side portion of the bead filler 9 is set to an outer peripheral side flow path 31c. A flow path wall of the inner peripheral side flow path 31b and a flow path wall of the outer peripheral side flow path 31c are preferably set to have the same level of wall surface length (which may be called as a land length) along the extending direction of the land portion 31. A wall surface length B of the flow path wall in the inner peripheral side flow path 31b is preferably between 60 and 200% of a wall surface length C of the flow path wall in the outer peripheral side flow path 31c, and is more preferably between 80 and 120%. The wall surface length B of the flow path wall in the inner peripheral side flow path 31b is particularly preferably equal to the wall surface length C of the flow path wall in the outer peripheral side flow path 31c.

The taper portion 32 is formed in such a manner that a cross sectional area of the flow path is reduced toward a downstream side from an upstream side. In the present embodiment, a center axis of the taper portion 32 is set to be identical to a center axis of the land portion 31.

The flow rate regulating portion 33 is provided in an upstream side of the land portion 31, and can regulate a rubber flow in such a manner that a flow rate of the rubber flowing to the outer peripheral side flow path 31c of the land portion 31 becomes larger than a flow rate of the rubber flowing to the inner peripheral side flow path 31b of the land portion 31. The present embodiment describes an example in which two flow paths having different shapes are formed in the flow rate regulating portion 33, thereby regulating the flow rate of the rubber. Specifically, the flow rate regulating portion 33 has a taper flow path 33a which supplies the rubber to the inner peripheral side flow path 31b of the land portion 31, and a straight flow path 33b which supplies the rubber to the outer peripheral side flow path 31c of the land portion 31. The taper flow path 33a and the straight flow path 33b have the same cross sectional area in their feed ports in the upstream side. The taper flow path 33a is formed into a taper shape toward a downstream side from the feed port, and then is formed to have a fixed cross sectional area. On the other hand, the straight flow path 33b is formed to have a fixed cross sectional area from an upstream side toward a downstream side. As a result, the flow rate of the rubber flowing through the straight flow path 33b becomes larger than the flow rate of the rubber flowing through the taper flow path 33a, so that it is possible to make the flow rate of the rubber flowing to the outer peripheral side flow path 31c of the land portion 31 larger than the flow rate of the rubber flowing to the inner peripheral side flow path 31b of the land portion 31.

A die 21 is provided in a leading end of the extruder 2. A rubber flow path through which the rubber supplied from the extruder 2 passes is formed in an inner portion of the die 21. The mouthpiece 3 is connected to the die 21, and the rubber supplied from the extruder 2 is led to the mouthpiece 3. A concave portion to which a flow rate regulating portion 33 of the mouthpiece 3 is fitted is formed in an end surface 21a of the die 21.

The end surface 21a of the die 21 is formed so as to be inclined to the forming surface 4a of the table 4. An angle of gradient of the end surface 21a of the die 21 to the forming surface 4a is set to be equal to an angle of gradient θ of the leading end surface 3a of the mouthpiece 3 in relation to the forming surface 4a. In the case that the mouthpiece 3 is attached to the leading end of the extruder 2 without using the die 21, it is conceivable that the extruder 2 or the table 4, or both of the extruder 2 and the table 4 are inclined in order to make the leading end surface 3a of the mouthpiece 3 be inclined to the forming surface 4a of the table 4. However, in the case of forming bead fillers having a plurality of sizes, a mechanism which can change an angle of the extruder 2 or the table 4 is required. As a result, there is fear that cost increases, and an overall device is enlarged in size. Since it is possible to correspond to the bead filler having the plurality of sizes on the basis of the previously prepared dies 21 having the plurality of shapes by using the dies 21, it is possible to expect reduction in cost and compact structure of the overall device.

### Examples

A description will be given below of an example which specifically shows the structure and the effect of the present invention.

The bead filler 9 was formed, the bead filler 9 being structured such that lengths of the radial inner peripheral surface 9a and the upright side surface 9b are set to Examples 1 to 11 in Table 1 and having the approximately right triangular shape in the cross section. The bead filler having a desired cross sectional shape was able to precisely be formed in any of Examples 1 to 11 by setting a wall surface length B of the flow path wall of the inner peripheral side flow path 31b and a wall surface length C of the flow path wall of the outer peripheral side flow path 31c as described in Table 1 at this time.

TABLE 1

| | B( mm) | C (mm) | B/C (%) | 9a (mm) | 9b (mm) | 9a/9b |
|---|---|---|---|---|---|---|
| Example 1 | 10.5 | 6 | 175 | 17.9 | 68 | 0.26 |
| Example 2 | 7.3 | 5 | 146 | 8.7 | 32 | 0.27 |
| Example 3 | 8.5 | 4.9 | 173 | 20.2 | 73.7 | 0.27 |
| Example 4 | 8.7 | 4.4 | 198 | 21.1 | 76.7 | 0.28 |
| Example 5 | 8.9 | 7.5 | 84 | 18 | 57.7 | 0.31 |
| Example 6 | 6.6 | 5.6 | 118 | 8.8 | 27.3 | 0.32 |
| Example 7 | 5.2 | 8.2 | 63 | 8.4 | 17.7 | 0.47 |
| Example 8 | 11.4 | 10.7 | 107 | 19.3 | 32.1 | 0.6 |
| Example 9 | 11 | 11.3 | 97 | 20.2 | 32 | 0.63 |
| Example 10 | 12 | 12.4 | 97 | 21.6 | 32.4 | 0.67 |
| Example 11 | 11 | 13.4 | 82 | 20.7 | 28.5 | 0.73 |

### OTHER EMBODIMENTS

(1) In the embodiment mentioned above, the flow rate regulating portion 33 is shown by the example in which two flow paths having the different shapes are formed, thereby regulating the flow rate of the rubber. However, the structure of the flow rate regulating portion is not limited to this. For example, the flow rate regulating portion 33 may have a straight flow path supplying the rubber to the inner peripheral side flow path 31b of the land portion 31, and a straight flow path supplying the rubber to the outer peripheral side flow path 31c of the land portion 31. Further, the flow rate regulating portion 33 may have a taper flow path supplying the rubber to the inner peripheral side flow path 31b of the land portion 31, and a taper flow path supplying the rubber to the outer peripheral side flow path 31c of the land portion 31. Further, the flow rate regulating portion 33 may have a straight flow path supplying the rubber to the inner peripheral side flow path 31b of the land portion 31, and a taper flow path supplying the rubber to the outer peripheral side flow path 31c of the land portion 31. Further, the straight flow path or the taper flow path supplying the rubber to the inner peripheral side flow path 31b, and the straight flow path or the taper flow path supplying the rubber to the outer peripheral side flow path 31c are not necessarily set to have the same cross sectional area in the feed port in the upstream side.

Further, a function of the flow rate regulating portion may be applied to the taper portion 32, for example, by engraving the outer peripheral side flow path wall of the taper portion 32 connected to the outer peripheral side flow path 31c of the land portion 31 more than the inner peripheral side flow path wall of the taper portion 32 connected to the inner peripheral side flow path 31b of the land portion 31 (or engraving the flow path wall of the outer peripheral side flow path 31c or performing both of the engraving operations).

(2) The leading end surface 3a of the mouthpiece 3 may be formed into the other shapes than the flat surface in correspondence to the cross sectional shape of the bead filler 9 to be formed, as shown in FIG. 4.

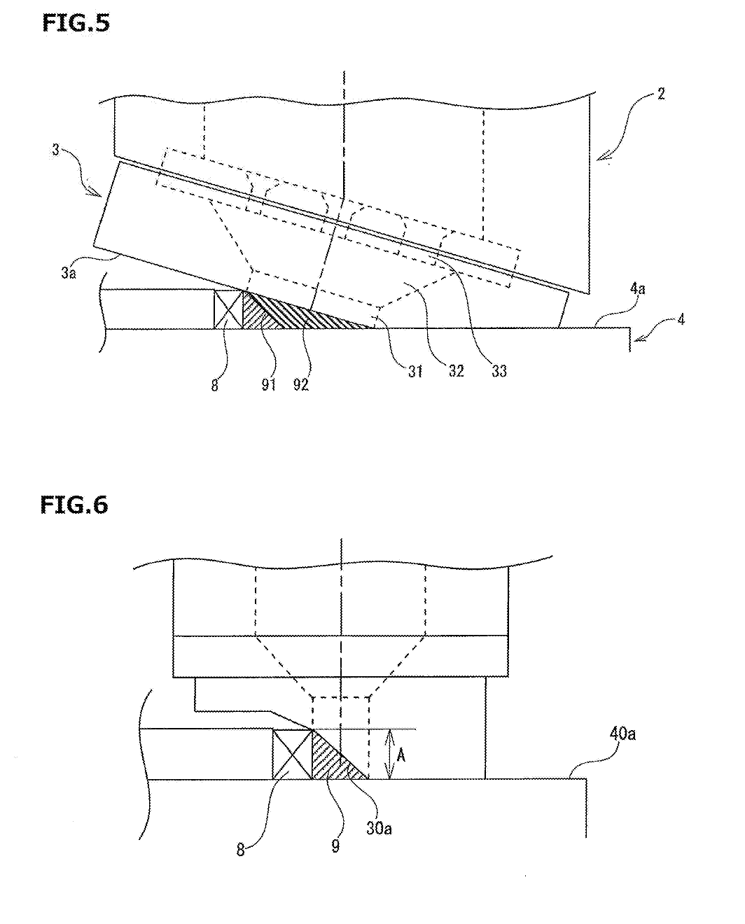

(3) The bead filler 9 may be formed of a plurality of rubbers. As shown in FIG. 5, an outer peripheral surface 92 of the bead filler 9 may be formed by three surfaces including the leading end surface 3a of the mouthpiece 3, the forming surface 4a of the table 4, and an inclined side surface of an inner peripheral portion 91, after forming the inner peripheral portion 91 of the bead filler 9.

(4) The embodiments describe the example in which the rotating shaft of the screw for extruding the rubber built in the extruder 2 is arranged in parallel to the rotating shaft 41 of the table 4, however, the rotating shaft of the screw may be arranged in parallel to the center axis of the land portion 31.

What is claimed is:

1. A bead filler forming device comprising:
an extruder;
a rotating table; and
a mouthpiece,
the bead filler forming device being configured to form a bead filler by annularly applying, to a forming surface of the rotating table, rubber extruded via the mouthpiece from the extruder in a band shaped manner, and by joining end portions of the band-shaped rubber,
wherein the mouthpiece includes:
a leading end surface which is arranged to be inclined in relation to the forming surface of the rotating table in such a manner that a distance from the forming surface of the rotating table is larger in an inner peripheral side of the leading end surface than in an outer peripheral side of the leading end surface;
a discharge port which is formed in the leading end surface;
a land portion which extends from the discharge port in a single cross section in such a manner as to be inclined to an outer peripheral side of the rotating table in relation to a rotating shaft of the rotating table toward a direction of being away from the forming surface; and
a flow rate regulating portion which is provided in an upstream side of the land portion and makes a flow rate of the rubber flowing to an outer peripheral side flow path of the land portion larger than a flow rate of the rubber flowing to an inner peripheral side flow path of the land portion.

2. The bead filler forming device according to claim 1, wherein a wall surface length of a flow path wall in the inner peripheral side flow path is between 60 and 200% of a wall surface length of a flow path wall in the outer peripheral side flow path.

3. The bead filler forming device according to claim 1, wherein a wall surface length of a flow path wall in the inner peripheral side flow path is equal to a wall surface length of a flow path wall in the outer peripheral side flow path.

4. The bead filler forming device according to claim 1, wherein a rubber flowing direction in the land portion is equal to a rubber flowing direction in the flow rate regulating portion.

5. The bead filler forming device according to claim 1, wherein a rotating shaft of a screw for extruding the rubber built in the extruder is arranged in parallel to the rotating shaft of the rotating table.

6. The bead filler forming device according to claim 5, wherein
a leading end of the extruder is provided with a die which leads the rubber supplied from the extruder to the mouthpiece, and
a leading end surface of the die is formed to be inclined in relation to the forming surface of the rotating table in such a manner that a distance from the forming surface of the rotating table is larger in an inner peripheral side of the leading end surface than in an outer peripheral side of the leading end surface.

7. The bead filler forming device according to claim 6, wherein an angle of gradient of the leading end surface of the die in relation to the forming surface is set to be equal to an angle of gradient of the leading end surface of the mouthpiece in relation to the forming surface.

8. The bead filler forming device according to claim 1, wherein
the flow rate regulating portion has a first taper flow path which supplies the rubber to the inner peripheral side flow path, and a second taper flow path which supplies the rubber to the outer peripheral side flow path, and
each of the first taper flow path and the second taper flow path has a feed port, is formed into a taper shape from the feed port in an upstream side toward a downstream side, and then is formed to have a fixed cross sectional area.
